(19) United States
(12) Patent Application Publication
(10) Pub. No.: US 2025/0081247 A1
(43) Pub. Date: Mar. 6, 2025

(54) APPARATUS AND METHOD OF PDCCH ORDER RACH FOR MOBILITY

(71) Applicant: GUANGDONG OPPO MOBILE TELECOMMUNICATIONS CORP., LTD., Dongguan (CN)

(72) Inventor: Li GUO, Allen, TX (US)

(21) Appl. No.: 18/951,019

(22) Filed: Nov. 18, 2024

Related U.S. Application Data
(63) Continuation of application No. PCT/CN2023/136590, filed on Dec. 5, 2023.
(60) Provisional application No. 63/386,146, filed on Dec. 5, 2022.

(51) Int. Cl. H04W 74/0833; H04W 76/38

(52) U.S. Cl. CPC H04W 74/0833; H04W 76/38

(57) ABSTRACT

A method of PDCCH order RACH for mobility, by a UE includes receiving, from a base station, a configuration of a first list of candidate cells, receiving, from the base station, a RACH configuration for each non-serving cell contained in the first list of candidate cells, and receiving, from the base station, a first control signaling, wherein the first control signaling indicates the UE to transmit a PRACH to a first non-serving cell contained in the first list of candidate cells.

### CROSS-REFERENCE TO RELATED APPLICATION

This application is a Continuation Application of International Application No. PCT/CN2023/136590 filed on Dec. 5, 2023, which claims priority to U.S. Provisional Application No. 63/386,146, filed on Dec. 5, 2022. The above referenced applications are incorporated herein by reference in their entirety.

### TECHNICAL FIELD

The present disclosure relates to the field of communication systems, and more particularly, to apparatuses and methods of physical downlink control channel (PDCCH) order random access channel (RACH) for mobility.

### BACKGROUND

The current physical downlink control channel (PDCCH) order physical random access channel (PRACH) cannot trigger a user equipment (UE) to transmit a PRACH preamble to a non-serving cell. Therefore, when the UE is connected with a serving cell, the UE cannot send a PRACH to a non-serving cell. The consequence is that the UE would have to perform a random access procedure to the non-serving cell when the UE is indicated to switch to that cell and a latency of switching cell is enlarged.

Therefore, there is a need for apparatuses and methods of physical downlink control channel (PDCCH) order random access channel (RACH) for mobility.

### SUMMARY

In a first aspect of the present disclosure, a method of physical downlink control channel (PDCCH) order random access channel (RACH) for mobility, by a user equipment (UE) includes receiving, from a base station, a configuration of a first list of candidate cells, receiving, from the base station, a RACH configuration for each non-serving cell contained in the first list of candidate cells, and receiving, from the base station, a first control signaling, wherein the first control signaling indicates the UE to transmit a physical random access channel (PRACH) to a first non-serving cell contained in the first list of candidate cells.

In a second aspect of the present disclosure, a UE includes a receiver configured to receive, from a base station, a configuration of a first list of candidate cells, receive, from the base station, a RACH configuration for each non-serving cell contained in the first list of candidate cells, and receive, from the base station, a first control signaling, wherein the first control signaling indicates the UE to transmit a physical random access channel (PRACH) to a first non-serving cell contained in the first list of candidate cells.

In a third aspect of the present disclosure, a UE includes a memory, a transceiver, and a processor coupled to the memory and the transceiver. The UE is configured to perform the above method.

In a fourth aspect of the present disclosure, a method of physical downlink control channel (PDCCH) order random access channel (RACH) for mobility, by a base station includes transmitting, to a user equipment (UE), a configuration of a first list of candidate cells, transmitting, to the UE, a RACH configuration for each non-serving cell contained in the first list of candidate cells, and transmitting, to the UE, a first control signaling, wherein the first control signaling indicates the UE to transmit a physical random access channel (PRACH) to a first non-serving cell contained in the first list of candidate cells.

In a fifth aspect of the present disclosure, a base station includes a transmitter configured to transmit, to a user equipment (UE), a configuration of a first list of candidate cells, transmit, to the UE, a RACH configuration for each non-serving cell contained in the first list of candidate cells, and transmit, to the UE, a first control signaling, wherein the first control signaling indicates the UE to transmit a physical random access channel (PRACH) to a first non-serving cell contained in the first list of candidate cells.

In a sixth aspect of the present disclosure, a base station includes a memory, a transceiver, and a processor coupled to the memory and the transceiver. The base station is configured to perform the above method.

In a seventh aspect of the present disclosure, a non-transitory machine-readable storage medium has stored thereon instructions that, when executed by a computer, cause the computer to perform the above method.

In an eighth aspect of the present disclosure, a chip includes a processor, configured to call and run a computer program stored in a memory, to cause a device in which the chip is installed to execute the above method.

In a ninth aspect of the present disclosure, a computer readable storage medium, in which a computer program is stored, causes a computer to execute the above method.

In a tenth aspect of the present disclosure, a computer program product includes a computer program, and the computer program causes a computer to execute the above method.

In an eleventh aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a flowchart of one or more user equipments (UEs) and a base station communicate in a communication network system according to an embodiment of the present disclosure.

FIG. 2 is a block diagram of one or more user equipments (UEs) and a base station of communication in a communication network system according to an embodiment of the present disclosure.

FIG. 3 is a block diagram of a UE according to an embodiment of the present disclosure.

FIG. 4 is a block diagram of a UE according to an embodiment of the present disclosure.

FIG. 5 is a flowchart illustrating a method of physical downlink control channel (PDCCH) order random access channel (RACH) for mobility performed by a UE according to an embodiment of the present disclosure.

FIG. 6 is a block diagram of a base station according to an embodiment of the present disclosure.

FIG. 7 is a block diagram of a base station according to an embodiment of the present disclosure.

FIG. 8 is a flowchart illustrating a method of physical downlink control channel (PDCCH) order random access channel (RACH) for mobility performed by a base station according to an embodiment of the present disclosure.

FIG. 9 is a flowchart illustrating a method of physical downlink control channel (PDCCH) order random access channel (RACH) for mobility according to an embodiment of the present disclosure.

FIG. 10 is a block diagram of an example of a computing device according to an embodiment of the present disclosure.

FIG. 11 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. The terminologies in the embodiments of the present disclosure are merely for describing the purpose of the certain embodiment, but not to limit the disclosure.

The technical solutions of the embodiments of the present disclosure can be applied to various communication systems, such as a global system of mobile communication (GSM) system, a code division multiple access (CDMA) system, a wideband code division multiple access (WCDMA) system, a general packet radio service (GPRS), a long term evolution (LTE) system, a LTE frequency division duplex (FDD) system, a LTE time division duplex (TDD) system, an advanced long term evolution (LTE-A) system, a new radio (NR) system, an evolution system of a NR system, a LTE-based access to unlicensed spectrum (LTE-U) system, a NR-based access to unlicensed spectrum (NR-U) system, an universal mobile telecommunication system (UMTS), a global interoperability for microwave access (WiMAX) communication system, wireless local area networks (WLAN), wireless fidelity (Wi-Fi), a future 5th generation (5G) system (may also be called a new radio (NR) system) or other communication systems, etc.

Optionally, a base station mentioned in the embodiments of the present application can provide a communication coverage for a specific geographic area and can communicate with a user equipment (UE) located in the coverage area. Optionally, the base station may be a gNB, a base transceiver station (BTS) in the GSM or in the CDMA system, or may be a NodeB (NB) in the WCDMA system, or may be an evolutional Node B (eNB or eNodeB) in the LTE system, or a radio controller in a cloud radio access network (CRAN).

A user equipment (UE) may refer to an access terminal, a subscriber unit, a subscriber station, a mobile station, a remote station, a remote terminal, a mobile device, a user terminal, a terminal, a wireless communication device, a user agent, or a user device. The access terminal may be a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, a terminal device in a future 5G network, a terminal device in a future evolved PLMN, etc.

Optionally, the communication system in the embodiment of the present application may be applied to an unlicensed spectrum, where the unlicensed spectrum may also be considered as a shared spectrum; or the communication system in the embodiment of the present application may also be applied to a licensed spectrum, where the licensed spectrum can also be considered an unshared spectrum.

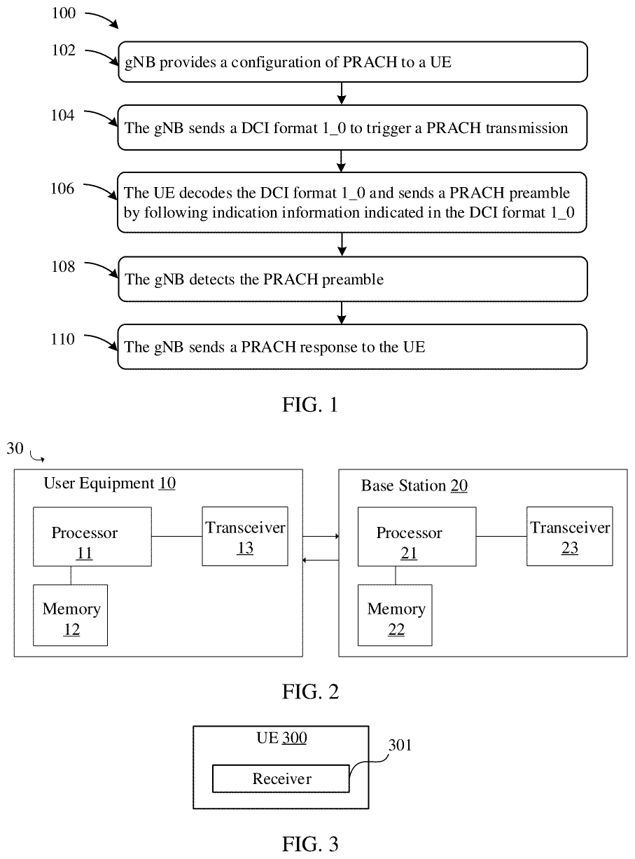

New radio (NR)/fifth generation (5G) system supports physical downlink control channel (PDCCH) order physical random access channel (PRACH) transmission. PDCCH order PRACH transmission is a mechanism by which a base station such as a gNB (next generation NodeB) can order a user equipment (UE) to initiate a PRACH transmission. One example use case for this mechanism is when the gNB finds that timing between the gNB and the UE needs further improvement, the gNB can order the UE to transmit a PRACH and then the gNB can measure uplink timing. In NR/5G system, the gNB use a downlink control information (DCI) format 0_1 to trigger the PDCCH order PRACH transmission. The basic procedure 100 illustrated in FIG. 1 includes an operation 102, gNB provides a configuration of PRACH to a UE, an operation 104, the gNB sends a DCI format 1_0 to trigger a PRACH transmission, an operation 106, the UE decodes the DCI format 1_0 and sends a PRACH preamble by following indication information indicated in the DCI format 1_0, an operation 108, the gNB detects the PRACH preamble, and an operation 110, the gNB sends a PRACH response to the UE.

As illustrated in FIG. 1, the gNB first provides the configuration of PRACH to the UE. When the gNB needs a PRACH for example to refine the timing, the gNB can send a DCI format 1_0 to trigger the UE to transmit the PRACH. When the UE receives the DCI format 1_0 for PDCCH order PRACH, the UE choose a PRACH preamble by following the configuration provided by the gNB and then transmits the selected PRACH preamble in the corresponding PRACH resource. Then the gNB detects the PRACH preamble and after that, the gNB sends a response to the UE.

The DCI format 1_0 that the gNB uses to trigger PRACH transmission has the following fields:

Random Access Preamble Index: that is used to indicate an index of a PRACH preamble that the UE chooses to transmit.

Uplink (UL)/supplementary uplink (SUL) indicator: this field is used to indicate which uplink carrier in the cell to transmit the PRACH.

Synchronization signal/physical broadcast channel (SS/PBCH) index: this field indicates the SS/PBCH that is used to determine a RACH occasion for the PRACH transmission.

PRACH mask index: this field indicates the RACH occasion associated with the SS/PBCH indicated by “SS/PBCH index” for the PRACH transmission.

In NR/5G system, the PDCCH order PRACH can be used to trigger either a contention-based random access procedure or contention-free random access procedure.

The current physical downlink control channel (PDCCH) order physical random access channel (PRACH) cannot trigger a user equipment (UE) to transmit a PRACH preamble to a non-serving cell. Therefore, when the UE is connected with a serving cell, the UE cannot send a PRACH to a non-serving cell. The consequence is that the UE would have to perform a random access procedure to the non-serving cell when the UE is indicated to switch to that cell and a latency of switching cell is enlarged.

Therefore, some embodiments of the present disclosure propose apparatuses and methods of physical downlink control channel (PDCCH) order random access channel (RACH) for mobility, which can solve issues in the prior art and other issues and/or reduce a latency of inter-cell mobility.

FIG. 2 illustrates that, in some embodiments, one or more user equipments (UEs) 10 and a base station (e.g., next generation NodeB (gNB) or eNB) 20 of communication in a communication network system 30 (e.g., an NR system) according to an embodiment of the present disclosure are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the transceiver 13 is configured to receive, from the base station 20, a configuration of a first list of candidate cells, receive, from the base station 20, a RACH configuration for each non-serving cell contained in the first list of candidate cells, and receive, from the base station 20, a first control signaling, wherein the first control signaling indicates the UE 10 to transmit a physical random access channel (PRACH) to a first non-serving cell contained in the first list of candidate cells. This can solve issues in the prior art and other issues and/or reduce a latency of inter-cell mobility.

In some embodiments, the transceiver 23 is configured to transmit, to the UE 10, a configuration of a first list of candidate cells, transmit, to the UE 10, a RACH configuration for each non-serving cell contained in the first list of candidate cells, and transmit, to the UE 10, a first control signaling, wherein the first control signaling indicates the UE 10 to transmit a physical random access channel (PRACH) to a first non-serving cell contained in the first list of candidate cells. This can solve issues in the prior art and other issues and/or reduce a latency of inter-cell mobility.

FIG. 3 illustrates an example of a UE 300 according to an embodiment of the present application. The UE 300 is configured to implement some embodiments of the disclosure. Some embodiments of the disclosure may be implemented into the UE 300 using any suitably configured hardware and/or software. The UE 300 includes a receiver 301 configured to receive, from a base station, a configuration of a first list of candidate cells, receive, from the base station, a RACH configuration for each non-serving cell contained in the first list of candidate cells, and receive, from the base station, a first control signaling, wherein the first control signaling indicates the UE to transmit a physical random access channel (PRACH) to a first non-serving cell contained in the first list of candidate cells. This can solve issues in the prior art and other issues and/or reduce a latency of inter-cell mobility.

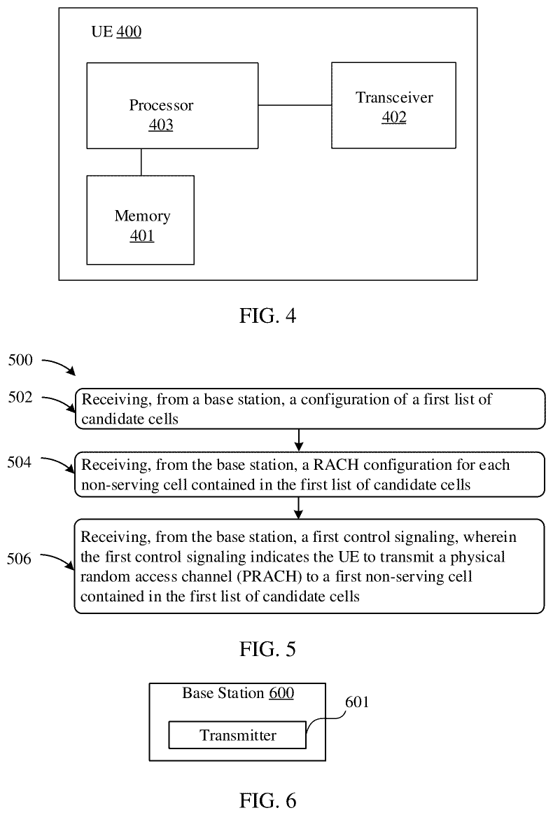

FIG. 4 illustrates an example of a UE 400 according to an embodiment of the present disclosure. The UE 400 is configured to implement some embodiments of the disclosure. Some embodiments of the disclosure may be implemented into the UE 400 using any suitably configured hardware and/or software. The UE 400 may include a memory 401, a transceiver 402, and a processor 403 coupled to the memory 401 and the transceiver 402. The processor 403 may be configured to implement proposed functions, procedures and/or methods described in this description. Layers of radio interface protocol may be implemented in the processor 403. The memory 401 is operatively coupled with the processor 403 and stores a variety of information to operate the processor 403. The transceiver 402 is operatively coupled with the processor 403, and the transceiver 402 transmits and/or receives a radio signal. The processor 403 may include application-specific integrated circuit (ASIC), other chipset, logic circuit and/or data processing device. The memory 401 may include read-only memory (ROM), random access memory (RAM), flash memory, memory card, storage medium and/or other storage device. The transceiver 402 may include baseband circuitry to process radio frequency signals. When the embodiments are implemented in software, the techniques described herein can be implemented with modules (e.g., procedures, functions, and so on) that perform the functions described herein. The modules can be stored in the memory 401 and executed by the processor 403. The memory 401 can be implemented within the processor 403 or external to the processor 403 in which case those can be communicatively coupled to the processor 403 via various means as is known in the art.

In some embodiments, the transceiver 402 is configured to receive, from a base station, a configuration of a first list of candidate cells, receive, from the base station, a RACH configuration for each non-serving cell contained in the first list of candidate cells, and receive, from the base station, a first control signaling, wherein the first control signaling indicates the UE to transmit a physical random access channel (PRACH) to a first non-serving cell contained in the first list of candidate cells. This can solve issues in the prior art and other issues and/or reduce a latency of inter-cell mobility.

FIG. 5 is an example of a method 500 of physical downlink control channel (PDCCH) order random access channel (RACH) for mobility performed by a UE according to an embodiment of the present disclosure. The method 500 of physical downlink control channel (PDCCH) order random access channel (RACH) for mobility performed by a UE is configured to implement some embodiments of the disclosure. Some embodiments of the disclosure may be implemented into the method 500 of physical downlink control channel (PDCCH) order random access channel (RACH) for mobility performed by a UE using any suitably configured hardware and/or software. In some embodiments, the method 500 of physical downlink control channel (PDCCH) order random access channel (RACH) for mobility performed by a UE includes: an operation 502, receiving, from a base station, a configuration of a first list of candidate cells, an operation 504, receiving, from the base station, a RACH configuration for each non-serving cell contained in the first list of candidate cells, and an operation 506, receiving, from the base station, a first control signaling, wherein the first control signaling indicates the UE to transmit a physical random access channel (PRACH) to a first non-serving cell contained in the first list of candidate cells. This can solve issues in the prior art and other issues and/or reduce a latency of inter-cell mobility.

In some embodiments, the method further includes transmitting a PRACH preamble according to the configuration of the first list of candidate cells, the RACH configuration, and the first control signaling. In some embodiments, the UE is configured to transmitting the PRACH preamble to the first non-serving cell for the first non-serving cell to measure uplink timing of the UE. In some embodiments, the method further includes receiving a RACH response from the base station. In some embodiments, the configuration of the first list of candidate cells and/or the RACH configuration is transmitted in a radio resource control (RRC). In some embodiments, the first control signaling includes a media access control (MAC) control element (CE) or a downlink control information (DCI). In some embodiments, the DCI is a DCI format X or DCI format 1_0.

In some embodiments, the first control signaling indicates one or more of the following information: an indicator to indicate the first non-serving cell in the first list of candidate cell, which the UE is indicated to transmit the PRACH preamble to, an indicator of a synchronization signal/physical broadcast channel (SS/PBCH) of a cell, an indicator of a random access preamble index, an indicator of a PRACH mask index, and/or an indicator to indicate whether a random access response (RAR) message is expected by the UE.

FIG. 6 illustrates an example of base station 600 according to an embodiment of the present application. The base station 600 is configured to implement some embodiments of the disclosure. Some embodiments of the disclosure may be implemented into the base station 600 using any suitably configured hardware and/or software. The base station 600 includes a transmitter 601 configured to transmit, to a user equipment (UE), a configuration of a first list of candidate cells, transmit, to the UE, a RACH configuration for each non-serving cell contained in the first list of candidate cells, and transmit, to the UE, a first control signaling, wherein the first control signaling indicates the UE to transmit a physical random access channel (PRACH) to a first non-serving cell contained in the first list of candidate cells.

FIG. 7 illustrates an example of a base station 700 according to an embodiment of the present disclosure. The base station 700 is configured to implement some embodiments of the disclosure. Some embodiments of the disclosure may be implemented into the base station 700 using any suitably configured hardware and/or software. The base station 700 may include a memory 701, a transceiver 702, and a processor 703 coupled to the memory 701 and the transceiver 702. The processor 703 may be configured to implement proposed functions, procedures and/or methods described in this description. Layers of radio interface protocol may be implemented in the processor 703. The memory 701 is operatively coupled with the processor 703 and stores a variety of information to operate the processor 703. The transceiver 702 is operatively coupled with the processor 703, and the transceiver 702 transmits and/or receives a radio signal. The processor 703 may include application-specific integrated circuit (ASIC), other chipset, logic circuit and/or data processing device. The memory 701 may include read-only memory (ROM), random access memory (RAM), flash memory, memory card, storage medium and/or other storage device. The transceiver 702 may include baseband circuitry to process radio frequency signals. When the embodiments are implemented in software, the techniques described herein can be implemented with modules (e.g., procedures, functions, and so on) that perform the functions described herein. The modules can be stored in the memory 701 and executed by the processor 703. The memory 701 can be implemented within the processor 703 or external to the processor 703 in which case those can be communicatively coupled to the processor 703 via various means as is known in the art.

In some embodiments, the transceiver 702 is configured to transmit, to a user equipment (UE), a configuration of a first list of candidate cells, transmit, to the UE, a RACH configuration for each non-serving cell contained in the first list of candidate cells, and transmit, to the UE, a first control signaling, wherein the first control signaling indicates the UE to transmit a physical random access channel (PRACH) to a first non-serving cell contained in the first list of candidate cells. This can solve issues in the prior art and other issues and/or reduce a latency of inter-cell mobility.

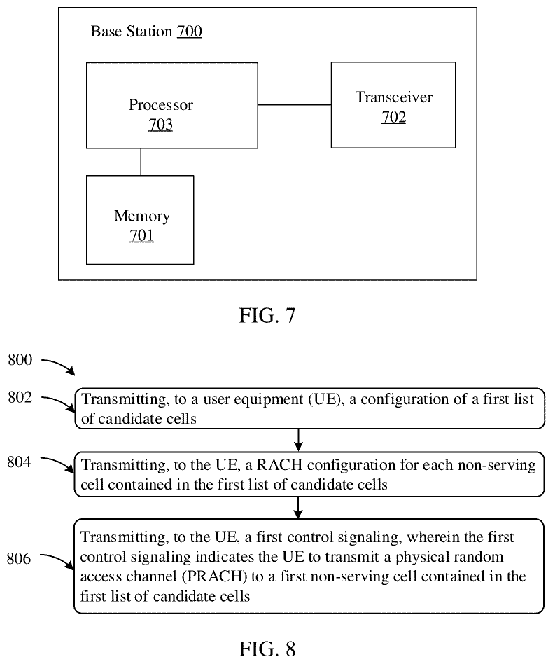

FIG. 8 is an example of a method 800 of physical downlink control channel (PDCCH) order random access channel (RACH) for mobility performed by a base station according to an embodiment of the present disclosure. The method 800 of physical downlink control channel (PDCCH) order random access channel (RACH) for mobility performed by the base station is configured to implement some embodiments of the disclosure. Some embodiments of the disclosure may be implemented into the method 800 of physical downlink control channel (PDCCH) order random access channel (RACH) for mobility performed by the base station using any suitably configured hardware and/or software. In some embodiments, the method 800 of physical downlink control channel (PDCCH) order random access channel (RACH) for mobility performed by the base station includes: an operation 802, transmitting, to a user equipment (UE), a configuration of a first list of candidate cells, an operation 804, transmitting, to the UE, a RACH configuration for each non-serving cell contained in the first list of candidate cells, and an operation 806, transmitting, to the UE, a first control signaling, wherein the first control signaling indicates the UE to transmit a physical random access channel (PRACH) to a first non-serving cell contained in the first list of candidate cells. This can solve issues in the prior art and other issues and/or reduce a latency of inter-cell mobility.

In some embodiments, the method further includes receiving, from the UE, a PRACH preamble according to the configuration of the first list of candidate cells, the RACH configuration, and the first control signaling. In some embodiments, the base station in the first non-serving cell is configured to receive the PRACH preamble to measure uplink timing of the UE. In some embodiments, the method further includes transmitting a RACH response to the UE. In some embodiments, the configuration of the first list of candidate cells and/or the RACH configuration is transmitted in a radio resource control (RRC). In some embodiments, the first control signaling includes a media access control (MAC) control element (CE) or a downlink control information (DCI). In some embodiments, the DCI is a DCI format X or DCI format 1_0.

In some embodiments, the first control signaling indicates one or more of the following information: an indicator to indicate the first non-serving cell in the first list of candidate cell, which the base station indicates the UE to transmit the PRACH preamble to, an indicator of a synchronization signal/physical broadcast channel (SS/PBCH) of a cell, an indicator of a random access preamble index, an indicator of a PRACH mask index, and/or an indicator to indicate whether a random access response (RAR) message is expected by the UE.

### Exemplary Technical Solutions

In some embodiments, a serving gNB can provide a first list of candidate cell(s) to a UE, where the list of candidate cell(s) can be a list of physical cell ID(s) that indicate one or more non-serving cells that are candidate for mobility. The gNB can also provide a RACH configuration for each cell contained in the first list of candidate cell(s). In other word, for one cell contained in the first list of candidate cell(s), there is one configuration of RACH transmission. Then, the gNB can indicate a UE to transmit a PRACH towards to the first non-serving cell contained in the first list of candidate cell(s). The gNB can provide the configuration of PRACH of one or more non-serving cells to the UE. The gNB can send a first control signaling (for example one MAC CE or for example one DCI) to indicate the UE to transmit PRACH to a first non-serving cell. The first control signaling can indicate one or more of the following information:

One indicator to indicate a first non-serving cell in the first list of candidate cell, which the UE is indicate to transmit PRACH preamble to.

An indicator of a SS/PBCH of a cell. This field can indicate a SS/PBCH of a non-serving cell. The UE can be requested to use this indicated SS/PBCH to determine RACH occasion for the PRACH transmission.

An indicator of a random access preamble index. This field can indicate one PRACH preamble for the UE to transmit.

An indicator of a PRACH mask index. This field can be used to indicate the RACH occasion for PRACH transmission.

An indicator to indicate whether a RAR (random access response) message is expected by the UE.

In some embodiments, when receiving the first control signaling, the UE can be requested to transmit a PRACH preamble in a determined PRACH occasion towards to the first non-serving cell. In one example, the UE can be indicated to a RACH occasion for PRACH transmission based on one indicated SS/PBCH of the first non-serving cell. The UE can be requested to determine the uplink transmission configuration for transmitting PRACH preamble based on the indicated SS/PBCH of the first non-serving cell, where the uplink transmission configuration can include a spatial transmit filter and/or an uplink transmit power. In some embodiments, when receiving the PRACH preamble transmission from the UE, the gNB can determine a timing advance value for uplink transmission towards the first non-serving cell. The gNB can indicate the timing advance for uplink transmission to the first non-serving cell to the UE.

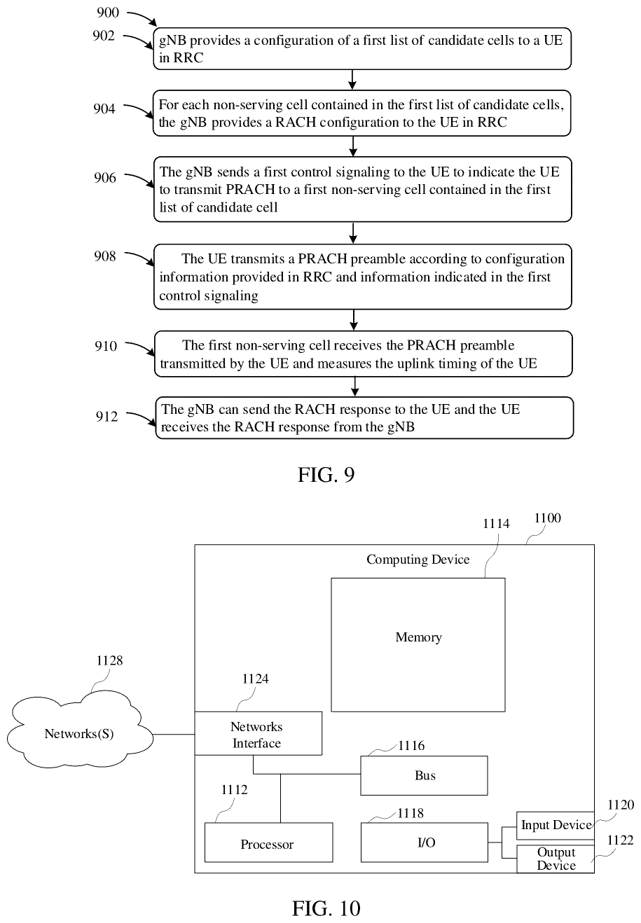

FIG. 9 illustrates a method of physical downlink control channel (PDCCH) order random access channel (RACH) for mobility according to an embodiment of the present disclosure. In some embodiments, the method 900 of physical downlink control channel (PDCCH) order random access channel (RACH) for mobility illustrates a procedure of RACH towards a non-serving cell and includes: an operation 902, gNB provides a configuration of a first list of candidate cells to a UE in RRC, an operation 904, for each non-serving cell contained in the first list of candidate cells, the gNB provides a RACH configuration to the UE in RRC, an operation 906, the gNB sends a first control signaling to the UE to indicate the UE to transmit PRACH to a first non-serving cell contained in the first list of candidate cell, an operation 908, the UE transmits a PRACH preamble according to configuration information provided in RRC and information indicated in the first control signaling, an operation 910, the first non-serving cell receives the PRACH preamble transmitted by the UE and measures the uplink timing of the UE, an operation 912, the gNB can send the RACH response to the UE and the UE receives the RACH response from the gNB. This can solve issues in the prior art and other issues and/or reduce a latency of inter-cell mobility.

In some examples, the gNB can use one DCI format X to trigger the UE to transmit PRACH preamble towards to a non-serving cell. The DCI format X can include one or more of the following bit fields:

An indicator to indicate one cell in the first list of candidate cells. This field can indicate a non-serving cell in the first list of candidate cells to which the UE is indicated to transmit a PRACH preamble. In one example, the size of this field can be zero if the UE is not configured with L1/L2 triggered mobility. In one example, the size of this field can be N bits if the UE is configured with L1/L2 triggered mobility. In one example, the size of this field can be N bits if the UE is provided with the first list of candidate cells and the size of N=┌log₂(L+1)┐, where L is the number of cells configured in the first list of candidate cells.

An indicator of a SS/PBCH of a cell. This field can indicate a SS/PBCH of a non-serving cell. The UE can be requested to use this indicated SS/PBCH to determine RACH occasion for the PRACH transmission.

An indicator of a random access preamble index. This field can indicate one PRACH preamble for the UE to transmit.

An indicator of a PRACH mask index. This field can be used to indicate the RACH occasion for PRACH transmission.

An indicator to indicate whether the UE expects a RAR message after sending the PRACH preamble.

In one example, the gNB can send one DCI format 1_0 to trigger a UE to transmit a PRACH transmission. Such a DCI format 1_0 can contain the following fields:

Random access preamble index: in one example it can be 6 bits. It can indicate one RACH preamble index.

UL/SUL indicator: in one example, this field can be 1 bit. This field indicates which UL carrier in the cell to transmit the PRACH.

SS/PBCH index: this field can be 6 bits. This field can indicate one SS/PBCH of the serving cell indicated by the field of “indicator of physical cell ID” that is used to determine the RACH occasion for the PRACH transmission.

PRACH mask index. This field can be 4 bits. This field can indicate the RACH occasion associated with the SS/PBCH indicated by “SS/PBCH index” for the PRACH transmission.

One indicator of physical cell ID (PCI): this field indicates which serving cell to transmit the PRACH. In one example, this field has 0 bit for UEs not configured with L1/L2 triggered mobility. In one example, this field has 0 bit for UEs not configured with a first list of candidate cells for L1/L2 triggered mobility. In one example, this field has ┌log₂(L+1)┐ bits for UE configured with a first list of candidate cells where the first list contains L candidate cells. In one example, one DCI code point of this field can indicate the UE to transmit PRACH preamble to the serving cell. For example, the DCI code point with all 0s indicate the UE to transmit PRACH preamble to the serving cell and the DCI code point 001 indicate the UE to transmit PRACH preamble to the non-serving cell of the first entry in the first list of candidate cells.

One indicator of RAR: this field indicates whether the UE expects RAR message after sending PRACH preamble. In one example, this field has 0 bit for UEs not configured with a list of candidate cells for L1/L2 triggered mobility. In one example, this field has 0 bit for UEs not configured with L1/L2 triggered mobility. In one example, this field has 1 bit for UEs configured with a list of candidate cells for L1/L2 triggered mobility.

In some embodiments, the gNB can provide a first list of candidate cells for L1/L2 triggered mobility and the gNB can provide configuration of RACH for each non-serving cell contained in the first list of candidate cells. The gNB provides configuration of RACH for the serving cell. The gNB can send one DCI format 1_0 to trigger the UE to transmit PRACH preamble to a non-serving cell in the first list of candidate cell or the serving cell. When the UE receives DCI format 1_0 that triggers PRACH transmission, the UE shall transmit the PRACH preamble according the indication in the DCI format 1_0 and the RACH configuration of the non-serving cell or serving cell indicated by the DCI format 1_0.

In one example, the UE determines the transmit power of the PRACH preamble transmission according to the SSB of the indicated serving cell or non-serving cell that is indicated by the DCI format 1_0. In one example, the UE determines the uplink transmit timing of the PRACH preamble transmission according to the DL timing of the serving cell or non-serving cell that is indicated by the DCI format 1_0. In one example, whether the UE expects RAR message after sending PRACH preamble towards a non-serving cell can be indicated by the DCI format 1_0. One DCI field in the DCI format 1_0 can be used to indicate whether the UE expects RAR message after sending PRACH preamble according to the indication in DCI format 1_0.

In one example, whether the UE expects RAR message after sending PRACH preamble towards a non-serving cell can be configured through RRC. For example, the gNB can provide one indicator for a first non-serving cell in the first list of candidate cells and the indicator can indicate whether the UE expects RAR message after sending PRACH preamble towards to the first non-serving cell. For example, the gNB can provide on indicator in RRC that indicate whether the UE expects RAR message after sending PRACH preamble towards to one non-serving cell in the first list of candidate cells. The proposed some embodiments can reduce the latency of inter-cell mobility. Before switching to the target cell (which is a non-serving cell), the serving cell gNB can trigger the UE to transmit PRACH to the target cell so that the uplink timing to that non-serving cell can be obtained before the UE switches to the target cell.

Commercial interests for some embodiments are as follows. 1. Solve issues in the prior art and other issues. 2. Reduce a latency of inter-cell mobility. 3. Provide a good communication performance. 4. Provide high reliability. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, and/or a communication system. Compatible products follow at least one proposed solution, method, system, and apparatus of some embodiments of the present disclosure. The proposed solution, method, system, and apparatus are widely used in a UE, a base station, and/or a communication system. With the implementation of the at least one proposed solution, method, system, and apparatus of some embodiments of the present disclosure, at least one modification to methods and apparatus of physical downlink control channel (PDCCH) order random access channel (RACH) for mobility are considered for standardizing.

FIG. 10 is an example of a computing device 1100 according to an embodiment of the present disclosure. Any suitable computing device can be used for performing the operations described herein. For example, FIG. 10 illustrates an example of the computing device 1100 that can implement some embodiments of FIG. 1 to FIG. 9 using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments of FIG. 1 to FIG. 9. The program code may be resident in the memory 1114 or any suitable computer-readable medium and may be executed by the processor 1112 or any other suitable processor.

The computing device 1100 can also include at least one network interface 1124. The network interface 1124 can include any device or group of devices suitable for establishing a wired or wireless data connection to one or more data networks 1128. Non limiting examples of the network interface 1124 include an Ethernet network adapter, a modem, and/or the like. The computing device 1100 can transmit messages as electronic or optical signals via the network interface 1124.

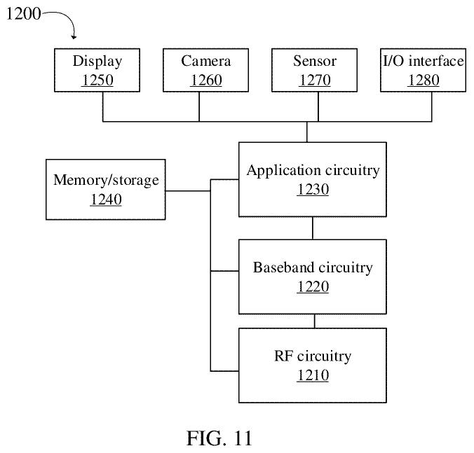

FIG. 11 is a block diagram of an example of a communication system 1200 according to an embodiment of the present disclosure. Embodiments described herein may be implemented into the communication system 1200 using any suitably configured hardware and/or software. FIG. 11 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to some embodiments of FIG. 1 to FIG. 9. The program code may be resident in the application circuitry 1230 or any suitable computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to some embodiments of FIG. 1 to FIG. 9 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

It is understood that the present disclosure is not limited to the disclosed embodiments but is intended to cover various arrangements made without departing from the scope of the broadest interpretation of the appended claims.

What is claimed is:

1. A method of physical downlink control channel (PDCCH) order random access channel (RACH) for mobility, by a user equipment (UE), comprising:
receiving, from a base station, a configuration of a first list of candidate cells;
receiving, from the base station, a RACH configuration for each non-serving cell contained in the first list of candidate cells; and
receiving, from the base station, a first control signaling, wherein the first control signaling indicates the UE to transmit a physical random access channel (PRACH) to a first non-serving cell contained in the first list of candidate cells.

2. The method of claim 1, further comprising transmitting a PRACH preamble according to the configuration of the first list of candidate cells, the RACH configuration, and the first control signaling.

3. The method of claim 2, wherein the UE is configured to transmitting the PRACH preamble to the first non-serving cell for the first non-serving cell to measure uplink timing of the UE.

4. The method of claim 2, further comprising receiving a RACH response from the base station.

5. The method of claim 1, wherein the configuration of the first list of candidate cells and/or the RACH configuration is transmitted in a radio resource control (RRC).

6. The method of claim 1, wherein the first control signaling comprises a media access control (MAC) control element (CE) or a downlink control information (DCI);
wherein the DCI is a DCI format X or DCI format 1_0.

7. The method of claim 1, wherein the first control signaling indicates one or more of the following information:
an indicator to indicate the first non-serving cell in the first list of candidate cell, which the UE is indicated to transmit the PRACH preamble to;
an indicator of a synchronization signal/physical broadcast channel (SS/PBCH) of a cell;
an indicator of a random access preamble index;
an indicator of a PRACH mask index;
an indicator to indicate whether a random access response (RAR) message is expected by the UE.

8. A user equipment (UE), comprising:
a memory;
a transceiver; and
a processor coupled to the memory and the transceiver;
wherein the UE is configured to perform:
receiving, from a base station, a configuration of a first list of candidate cells;
receiving, from the base station, a RACH configuration for each non-serving cell contained in the first list of candidate cells; and
receiving, from the base station, a first control signaling, wherein the first control signaling indicates the UE to transmit a physical random access channel (PRACH) to a first non-serving cell contained in the first list of candidate cells.

9. The UE of claim 8, further comprising transmitting a PRACH preamble according to the configuration of the first list of candidate cells, the RACH configuration, and the first control signaling.

10. The UE of claim 9, wherein the UE is configured to transmitting the PRACH preamble to the first non-serving cell for the first non-serving cell to measure uplink timing of the UE.

11. The UE of claim 9, further comprising receiving a RACH response from the base station.

12. The UE of claim 8, wherein the configuration of the first list of candidate cells and/or the RACH configuration is transmitted in a radio resource control (RRC).

13. The UE of claim 8, wherein the first control signaling comprises a media access control (MAC) control element (CE) or a downlink control information (DCI);
wherein the DCI is a DCI format X or DCI format 1_0.

14. The UE of claim 8, wherein the first control signaling indicates one or more of the following information:
an indicator to indicate the first non-serving cell in the first list of candidate cell, which the UE is indicated to transmit the PRACH preamble to;
an indicator of a synchronization signal/physical broadcast channel (SS/PBCH) of a cell;
an indicator of a random access preamble index;
an indicator of a PRACH mask index;
an indicator to indicate whether a random access response (RAR) message is expected by the UE.

15. A base station, comprising:
a memory;
a transceiver; and
a processor coupled to the memory and the transceiver;
wherein the base station is configured to perform:
transmitting, to a user equipment (UE), a configuration of a first list of candidate cells;
transmitting, to the UE, a RACH configuration for each non-serving cell contained in the first list of candidate cells; and
transmitting, to the UE, a first control signaling, wherein the first control signaling indicates the UE to transmit a physical random access channel (PRACH) to a first non-serving cell contained in the first list of candidate cells.

16. The method of claim 15, further comprising receiving, from the UE, a PRACH preamble according to the configuration of the first list of candidate cells, the RACH configuration, and the first control signaling.

17. The base station of claim 16, wherein the base station in the first non-serving cell is configured to receive the PRACH preamble to measure uplink timing of the UE.

18. The base station of claim 16, further comprising transmitting a RACH response to the UE.

19. The base station of claim 15, wherein the configuration of the first list of candidate cells and/or the RACH configuration is transmitted in a radio resource control (RRC).

20. The base station of claim 15, wherein the first control signaling comprises a media access control (MAC) control element (CE) or a downlink control information (DCI);
wherein the DCI is a DCI format X or DCI format 1_0;
and/or
the first control signaling indicates one or more of the following information:
an indicator to indicate the first non-serving cell in the first list of candidate cell, which the base station indicates the UE to transmit the PRACH preamble to;
an indicator of a synchronization signal/physical broadcast channel (SS/PBCH) of a cell;
an indicator of a random access preamble index;
an indicator of a PRACH mask index;
an indicator to indicate whether a random access response (RAR) message is expected by the UE.
